(19) United States
(12) Patent Application Publication
(10) Pub. No.: US 2004/0105348 A1
(43) Pub. Date: Jun. 3, 2004

(54) Magnetic recording device, recording device, and reproducing device

(75) Inventors: Kazuhisa Takayama, Tenri-shi (JP); Hiroshi Fuji, Soraku-gun (JP); Jyunichi Satoh, Nara-shi (JP); Kunio Kojima, Nabari-shi (JP); Akira Takahashi, Nara-shi (JP)

Correspondence Address: Dike, Bronstein, Roberts & Cushman, Intellectual Property Practice Group, Edwards & Angell, LLP, P.O. Box 9169, Boston, MA, 02209, US

(73) Assignee: Sharp Kabushiki Kaisha

(21) Appl. No.: 10/722,332

(22) Filed: Nov. 24, 2003

(30) Foreign Application Priority Data
Nov. 29, 2002 (JP) 2002-348826

(51) Int. Cl. G11B 11/00

(52) U.S. Cl. 369/13.45

(57) ABSTRACT

A magnetic recording medium which includes a first magnetic layer on a substrate is provided with a second magnetic layer having a greater largest possible absolute value of magnetization than the first magnetic layer within a temperature range of from a room temperature to a Curie temperature, and a metal layer made of metal having unspontaneous magnetization property. With this, it is possible to provide a magnetic recording medium having improved coersivity so as to realize stable recording and reproducing even if the size of a record unit is small.

This Nonprovisional application claims priority under 35 U.S.C. § 119(a) on Patent Application No. 2002/348826 filed in Japan on Nov. 29, 2002, the entire contents of which are hereby incorporated by reference.

### FIELD OF THE INVENTION

The present invention relates to a magnetic recording medium; and a recording device, reproducing device, and recording-reproducing device using the same. The present invention particularly relates to a magnetic recording medium whose magnetization in reproducing a signal is intensified.

### BACKGROUND OF THE INVENTION

One of information recording techniques widely used today is magnetic recording. In accordance with the recent advancement of information-oriented society, there is a growing demand for higher recording density in the magnetic recording. An example of a method which achieves the higher recording density is laser-assisted magnetic recording as disclosed in Japanese Unexamined Patent Publication No. 207723/2000 (Tokukai 2000-207723, published on Jul. 28, 2000). Note that, Tokukai 2000-207723 is hereinafter referred to as Document 1.

This method uses a magnetic recording medium having an arrangement in which a first carbon nitride film as a protection film, a magnetic film to be a recording area (having a layer thickness of 100 nm), a second carbon nitride film as a protection film (having a layer thickness of 20 nm), and a lubrication film are formed in this order on a glass substrate having a thickness of 0.635 mm. Note that, the magnetic film is made of TeFeCo which is an amorphous material having perpendicular magnetic anisotropy. The lubrication film is made of a perfluoropolyoxyalkane-type lubricant.

The magnetic recording medium like this has a ferrimagnet whose compensation temperature is around room temperature. Thus, the magnetic recording medium has very large coercivity at a temperature around the room temperature when carrying out no recording or reproducing, thereby causing almost no magnetic leakage flux.

When recording information, first, light is irradiated on the recording area of the magnetic recording medium so as to locally raise the temperature of the recording area. Specifically, the temperature of a minute area having a diameter of not more than 0.1 μm in the magnetic recording medium is raised. This considerably decreases the coercivity at the area whose temperature is raised. Then, a magnetic head applies to the minute area in the magnetic recording medium, an external magnetic field that is in accordance with information to be recorded, so as to form a record unit (bit) which is magnetized in a certain direction. Note that, other than the area whose temperature is raised, the magnetic recording medium retains large coercivity so as to stably retain a magnetic field, thereby causing no cross talk noise.

On the other hand, when reproducing information, light is irradiated on a reproducing area of the magnetic recording medium so as to locally raise the temperature of the reproducing area. This generates large magnetization at the area whose temperature is raised. The magnetic recording medium can reproduce the recorded information by reading this magnetization.

With the recording and reproducing method described above, the coercivity of the minute area considerably is decreased by focusing light to irradiate a small area so as to raise the temperature of the minute area. Thus, it becomes possible to easily change the direction of magnetic moment by applying a magnetic field from the magnetic head. Accordingly, it also becomes possible to easily form a record bit at an area having no record bit, and easily change the direction of the magnetic moment indicated by the record bit. As describe above, even if the magnetic head is wide, the size of the record unit can be reduced by narrowing the area irradiated by light. This increases the recording density.

Further, when reproducing information, large magnetization is generated only at the area whose temperature is raised by light irradiation. With this, it becomes possible to read only magnetic information that is recorded in the area. Therefore, it becomes possible to increase the resolution for reproducing information by focusing light so as to reduce an area to be heated.

On the other hand, Japanese Unexamined Patent Publication No. 134994/2001 (Tokukai 2001-134994, published on May 18, 2001) suggests a magneto-optical recording medium. This magneto-optical medium at least includes a recording layer (first magnetic layer) made of a perpendicular magnetic film; a magnetic flux forming layer (second magnetic layer) made of a perpendicular magnetic film, the magnetic flux forming layer being subjected to exchange coupling with the first magnetic field; and a reproducing layer (third magnetic layer) on which magnetization of the first magnetic layer is transferred by magnetostatic coupling with the second magnetic layer and the first magnetic layer when the temperature is raised. Further, the second magnetic film has a larger peak value of total magnetization and a higher Curie temperature than the first magnetic film. Note that, Tokukai 2001-134994 is hereinafter referred to as Document 2.

With the technique described in Document 2, the magneto-optical recording medium is provided with the reproducing layer as the third magnetic layer, the magnetic flux forming layer as the second magnetic layer, and the recording layer as the first magnetic layer. This increases the magnetostatic coupling force among the reproducing layer, the magnetic flux forming layer, and the recording layer. Accordingly, it becomes possible to transfer a smaller record domain to the recording layer so as to achive stable reproducing, thereby increasing a margin of reproducing power. Further, the magnetic flux forming layer generates magnetic leakage flux to be used for the magnetostatic coupling with the reproducing layer, whereas the recording layer realizes an excellent recording state. With this, it is possible to provide a super-resolution magneto-optical disk having a wide margin of reproducing power and capable of realizing excellent recording.

Incidentally, it is necessary to appropriately adjust the compensation temperature of the magnetic film as the recording area in order to realize the magneto-optical medium described in Document 1. Because of its composition, however, the magnetic film as the recording area generally has small magnetization per unit volume when the temperature is raised by light irradiation.

Further, it is required to reduce the thickness of the magnetic film because a thick thickness of the magnetic film renders the magnetic moment of the record unit unstable. Here, if the thickness of the magnetic film as the recording area is thin, magnetization per record unit decreases. In other words, such thin thickness of the magnetic film as the recording area reduces the size of the record unit of information so as to increase the recording density of information.

However, the magnetic recording medium of Document 1 has the following problems. Namely, when thickness of the magnetic film as the recording area is thin, (i) the signal strength of the magnetization, which is read out as a reproduction signal, is not sufficiently obtained, and (ii) coercivity required for fixating the magnetic moment of the record unit is not sufficiently achieved.

On the other hand, Document 2 suggests a method to use a reproducing layer having large magnetization so as to increase the magnetostatic coupling force among the reproducing layer, magnetic flux forming layer, and recording layer. This widens a margin of reproducing power.

Here, applying the method of Document 2 to the magnetic recording medium of Document 1 only results in a widened margin of the reproducing power, thus failing to obtain sufficient coercivetiy of the magnetic recording medium. Without sufficient coercivity), it is not possible to attain stable retention of recorded information and stable reproduction of the recorded information in a case the size of the record unit of the magnetic recording medium is small.

### SUMMARY OF THE INVENTION

In view of the foregoing problems, an object of the present invention is to provide a magnetic recording medium, recording device, and reproducing device capable of stably retaining recorded information and stably reproducing the recorded information even if the size of a record unit is small.

A magnetic recording medium of the present invention is arranged so as to include a substrate; a metal layer formed on the substrate, the metal layer having unspontaneous magnetization property; a first magnetic layer formed on the metal layer; and a second magnetic layer formed on the first magnetic layer, the second magnetic layer having a greater largest possible absolute value of magnetization than the first magnetic layer within a temperature range of from a room temperature to a Curie temperature.

The inventors of the present invention compared the magnetic recording medium of the present invention with the magnetic recording medium which is not provided with the second magnetic layer and the metal layer (hereinafter referred to as magnetic recording medium for comparison) with respect to the coercivity and the temperature dependency of the magnetization. Note that, in the comparison experiments, the sum of the volumes of the first magnetic layer and the second magnetic layer in the magnetic recording medium of the present invention was set to be equal to the volume of the first magnetic layer in the magnetic recording medium for comparison.

Diligent studies revealed that the magnetic recording medium of the present invention has larger coersivity and larger magnetization than the magnetic recording medium which is not provided with the second magnetic layer and the metal layer.

These results of comparison show that it is possible to increase the total coercivity and magnoetization of the magnetic recording medium by (i) increasing a ratio of (A) the volume of the second magnetic layer to (B) the sum of the volumes of the first magnetic layer and the second magnetic layer, and (ii) providing the metal layer to the magnetic recording medium. Therefore, even if the sum of the volumes of the first magnetic layer and the second magnetic layer is reduced, it is possible to maintain the total coercivity and magnetization of the magnetic recording medium by (i) increasing the ratio of the second magnetic layer to the sum of the volumes and (ii) providing the metal layer.

Namely, by providing the metal layer and the second magnetic layer, it is possible to have a higher coercivity and magnetization of the magnetic recording medium even if the size of the record unit is small so as to have a higher information recording density of the magnetic recording medium. Therefore, it is possible to intensify the signal to be detected by the magnetic head which reads information recorded on the magnetic recording medium, so as to increase the signal-to-noise ratio. Further, it is possible to increase the information recording density in the magnetic recording medium while maintaining the signal-to-noise ratio above a certain level.

Note that, a metal layer is not provided between a substrate and a magnetic film or between a substrate and a magnetic layer in Documents 1 and 2. Therefore, the magnetic recording medium described in Document 1 and the magneto-optical medium described in Document 2 cannot achieve as much coercivity as the magnetic recording medium of the present invention.

Further, a magnetic recording medium of the present invention which includes a substrate and a first magnetic layer is so arranged to include a second magnetic layer having a greater largest possible absolute value of magnetization than the first magnetic layer within a temperature range of from a room temperature to a Curie temperature; and a metal layer made of (containing) metal having unspontaneous magnetization property.

In this arrangement, the magnetic recording medium of the present invention is provided with the second magnetic layer and the metal layer. The inventors of the present invention compared the magnetic recording medium of the present invention with the magnetic recording medium which is not provided with the second magnetic layer and the metal layer (hereinafter referred to as magnetic recording medium for comparison) with respect to the coercivity and the temperature dependency of the magnetization. Note that, in the comparison experiments, the sum of the volumes of the first magnetic layer and the second magnetic layer in the magnetic recording medium of the present invention was set to be equal to the volume of the first magnetic layer in the magnetic recording medium for comparison.

Diligent studies revealed that the magnetic recording medium of the present invention has larger coersivity and larger magnetization than the magnetic recording medium which is not provided with the second magnetic layer and the metal layer.

These results of comparison show that it is possible to increase the total coercivity and magnoetization of the magnetic recording medium by (i) increasing a ratio of (A) the volume of the second magnetic layer to (B) the sum of the volumes of the first magnetic layer and the second magnetic layer, and (ii) providing the metal layer to the magnetic recording medium. Therefore, even if the sum of the volumes of the first magnetic layer and the second magnetic layer is reduced, it is possible to maintain the total coercivity and magnetization of the magnetic recording medium by (i) increasing the ratio of the second magnetic layer to the sum of the volumes and (ii) providing the metal layer.

Namely, by providing the metal layer and the second magnetic layer, it is possible to have a higher coercivity and magnetization of the magnetic recording medium even if the size of the record unit is small so as to have a higher information recording density of the magnetic recording medium. Therefore, it is possible to intensify the signal to be detected by the magnetic head which reads information recorded on the magnetic recording medium, so as to increase the signal-to-noise ratio. Further, it is possible to increase the information recording density in the magnetic recording medium while maintaining the signal-to-noise ratio above a certain level.

Further, a recording device of the present invention is so arranged to heating means for locally heating a magnetic recording medium which includes a substrate, a first magnetic layer, a second magnetic layer having a greater largest possible absolute value of magnetization than the first magnetic layer within a temperature range of from a room temperature to a Curie temperature, and a metal layer made of metal having unspontaneous magnetization property; and a magnetic head for applying a magnetic field on a portion heated by the heating means.

With this arrangement, while the heating means locally heats the magnetic recording medium, the magnetic head can apply a magnetic field to the heated portion of the magnetic recording medium. Therefore, it is possible to carry out laser-assisted magnetic recording on the magnetic recording medium, thereby recording information on the magnetic recording medium in high density.

Further, a reproducing device of the present invention is so arranged to include heating means for locally heating a magnetic recording medium which includes a substrate, a first magnetic layer, a second magnetic layer having a greater largest possible absolute value of magnetization than the first magnetic layer within a temperature range of from a room temperature to a Curie temperature, and a metal layer made of metal having unspontaneous magnetization property; and a magnetic head for detecting magnetization of a portion heated by the heating means.

With this arrangement, while the heating means locally heats the magnetic recording medium, the magnetic head can reproduce information from the heated portion of the magnetic recording medium. Therefore, it is possible to read information from the magnetic recording medium on which information is recorded in high density by the laser-assisted magnetic recording.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross-sectional view showing an embodiment of a magnetic recording medium of the present invention.

FIG. 2 is a cross-sectional view showing a magnetic recording medium to be compared with the magnetic recording medium of the present invention.

FIG. 3 is a graph showing temperature dependency of residual magnetization in the magnetic recording medium of FIG. 1 and the magnetic recording medium of FIG. 2.

FIG. 4 is a graph showing magnetic field dependency of magnetization in the magnetic recording medium of FIG. 1 and the magnetic recording medium of FIG. 2.

FIG. 5(a) is a perspective view showing an embodiment of a recording device (reproducing device) of the present invention. FIG. 5(b) is a cross-sectional view showing a part of the recording device (reproducing device) of FIG. 5(a) in the vicinity of a magnetic recording medium.

FIG. 6(a) is a view schematically showing magnetic moment and magnetic flux in the magnetic recording medium of FIG. 1. FIG. 6(b) is a graph showing temperature dependency of coercivity and magnetization in the magnetic recording medium of FIG. 1.

### DESCRIPTION OF THE EMBODIMENTS

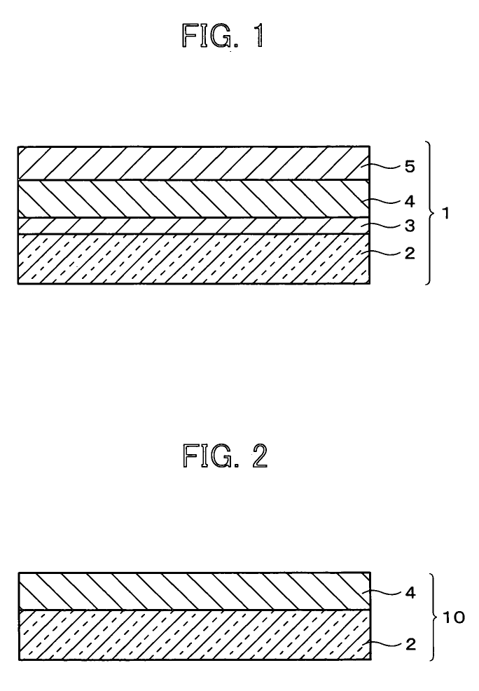

The following will explain an embodiment of the present invention with reference FIGS. 1 through 6(a) to 6(b).

[Arrangement of a Magnetic Recording Medium]

FIG. 1 is a cross-sectional view showing a magnetic recording medium 1 in accordance with an embodiment of the present invention. A substrate 2 used in the magnetic recording medium 1 is in a disk shape. The substrate 2 may be a disk made of glass, ceramics, or rigid plastic. Further, the substrate 2 may be prepared by forming a rigid layer such as NiP and alumite on a surface of an Al alloy plate. The rigid layer is provided mainly for planarizing the surface of the Al alloy plate. The following will explain a method for manufacturing the magnetic recording medium 1.

First, a metal layer 3 having unspontaneous magnetization property is formed on the substrate 2. Note that, the “metal layer having unspontaneous magnetization property” refers to a metal layer having a property that, when a magnetic field is removed, any magnetization is accordingly removed at every portion of the metal layer. In other words, the “metal layer having unspontaneous magnetization property” can be referred to as a “metal layer that does not have spontaneous magnetization property.”

The metal layer 3 is made of an Aluminum (Al) layer. Note that, the metal layer 3 is formed under the condition that argon (Ar) gas pressure is 0.5 Pa and throwing power is 300 W, and is formed to have a thickness of 10 nm. In other words, the metal layer 3 has a thickness of approximately 10 nm in a direction perpendicular to a surface of the substrate 2.

Further, the metal layer 3 provided on the substrate 2 is formed to have grains (roughness) on a surface. In other words, the metal layer 3 has the grains on a surface opposite to a surface facing the substrate 2. Note that, the density of the grains is 400 grains/μm² to 10000 grains/μm², and each grain has a diameter of 10 nm to 50 nm. The metal layer 3 as described above can increase the coercivity of the magnetic recording medium 1, thereby increasing the recording density.

Next, a first magnetic layer 4 is formed on the metal layer 3. The first magnetic layer 4 is a ferrimagnet made of alloy of rare earth metal and 3d transition metal (hereinafter referred to as “rare earth-3d transition metal alloy”). In the present embodiment, commonly used TbFeCo is employed as the first magnetic layer 4. Note that, the rare earth-3d transition metal alloy used for the first magnetic layer 4 may be alloy of at least one kind of rare earth metal and at least one kind of 3d transition metal, such as TbFe.

Further, the first magnetic layer 4 is formed by using DC (Direct Current) magnetron sputtering to have a thickness of 40 nm. Note that, the DC magnetron sputtering is carried out under the condition that argon (Ar) gas pressure is 0.4 Pa and throwing power is 300 W.

Note that, TbFeCo alloy is an alloy target for the DC magnetron sputtering (that is, TbFeCo alloy is sputtered to produce the first magnetic layer 4 made of TbFeCo alloy) in the present embodiment. The TbFeCo alloy has a composition ratio of Tb:Fe:Co=23.3:59.4:17.3 in percentage by atomic weight.

Next, a second magnetic layer 5 is formed on the first magnetic layer 4. The second magnetic layer 5 is a ferrimagnet made of rare earth-3d transition metal alloy. Note that, the second magnetic layer 5 includes at least one kind of rare earth metal other than the rare earth metal contained in the first magnetic layer 4.

Further, the rare earth-3d transition metal alloy used for the second magnetic layer 5 has a greater largest possible absolute value of magnetization for a temperature range of from a room temperature to a Curie temperature than the rare earth-3d transition metal alloy used for the first magnetic layer 4. Specifically, the largest possible absolute value of magnetization of the second magnetic layer 5 is preferably greater than the largest possible absolute value of magnetization of the first magnetic layer 4 by not less than 1.2 times.

Further, the coercivity of the rare earth-3d transition metal alloy used for the second magnetic layer 5 at a temperature in reproducing information is required to be small to such an extent that the magnetic moment of the second magnetic layer 5 can be magnetized uniformly in a desired direction by the magnetization generated by the rare earth-3d transition metal alloy used for the first magnetic layer 4.

In the present embodiment, the rare earth-3d transition metal alloy used for the second magnetic layer 5 is HoFeCo having a composition ratio of Ho:Fe:Co=19.8:62.1:18.1 in percentage by atomic weight. Note that, the rare earth-3d transition metal alloy used for the second magnetic layer 5 may be alloy composed of one kind of rare earth metal element and one kind of 3d transition metal element, such as HoFe.

Further, the second magnetic layer 5 is formed by using the DC magnetron sputtering in the same manner that the first magnetic layer 4 is formed. The second magnetic layer 5 is formed to have a thickness of 10 nm. Note that, the DC magnetron sputtering is carried out under the condition that the argon (Ar) gas pressure is 0.5 Pa and throwing power is 300 W.

Further, the second magnetic layer 5 preferably has a thickness of not less than 10 nm and not more than 50 nm. In other words, the second magnetic layer 5 preferably has a thickness of not less than 10 nm and not more than 50 nm in a direction perpendicular to the surface of the substrate 2.

Note that, a protection layer (not shown) such as a carbon nitride film and a lubrication film may be further provided on the second magnetic layer 5.

The inventors of the present invention considered that the effects of the metal layer 3 or the second magnetic layer 5 provided on the magnetic recording medium 1 as fabricated above could be demonstrated most properly by comparing the temperature dependency of residual magnetization between the magnetic recording medium 1 and a magnetic recording medium 10. The magnetic recording medium 10 was fabricated for comparison, as shown in FIG. 2. Here, the residual magnetization is magnetization remained in a magnetic body after reducing a magnetic field to 0 after the magnetic body is once saturated by the application of the magnetic field. The residual magnetization can be measured using a vibrating sample magnetometer (hereinafter referred to as VSM).

As shown in FIG. 2, the magnetic recording medium 10 is prepared by forming the first magnetic layer 4 on the substrate 2. The magnetic recording medium 10 is not provided with the second magnetic layer 5 and the metal layer 3. Further, members having the same arrangements in the magnetic recording medium 1 (FIG. 1) and the magnetic recording medium 10 (FIG. 2) are assigned with the same reference numerals. Further, the first magnetic layer 4 in the magnetic recording medium 10 has a thickness of 50 nm. This thickness is equal to the sum of the thickness of the first magnetic layer 4 and the second magnetic layer 5 in the magnetic recording medium 1.

Next, a method to measure the residual magnetization will be explained. First, a magnetic field was applied to the magnetic recording medium in a direction perpendicular to the film surface of the magnetic recording medium so as to saturate magnetization in the magnetic recording medium. After this, the magnetic field was reduced to 0, and the temperature of the magnetic recording medium was raised from around room temperature. Note that, it is generally preferable to saturate the magnetization in the magnetic recording medium at room temperature. However, if it is not possible to saturate the magnetization in the magnetic recording medium by applying to the magnetic recording medium the magnetic field that the VSM can apply, the magnetization in the magnetic recording medium may be saturated after raising or lowering the temperature of the magnetic recording medium to a temperature at which the magnetization can be saturated.

Further, the temperature of the magnetic recording medium during the measurement was raised at a rate of 2.5° C. per minute. Further, the magnetic recording medium together with a holding tool and vibration rod of the magnetic recording medium were placed in an air-tight quartz furnace in order to prevent the magnetic recording medium from reacting with air (mainly oxidation due to oxygen in air) when the magnetic recording medium is at a high temperature. Further, the pressure in the furnace was reduced to not more than 1.3×10⁻² Pa (not more than 1.0×10⁻⁴ Torr) by using a diffusion pump and a rotary pump.

In addition to the comparison of the temperature dependency of the residual magnetization as obtained in this manner, the inventors of the present invention considered that the effects of the magnetic recording medium 1 of the present embodiment could be made clear by comparing the largest possible values of residual magnetization between the magnetic recording mediums whose temperatures are raised.

Note that, the temperature of the magnetic recording medium was raised in comparing the magnetic recording mediums 1 and 10, because it is assumed here that the magnetic recording medium 1 is applied to the laser-assisted magnetic recording, for example. The laser-assisted magnetic recording is a recording method in which the information recording density of a magnetic recording medium is increased by utilizing the characteristics of a ferrimagnet at the compensation temperature, as disclosed in Japanese Unexamined Patent Publication No. 176034/1992 (Tokukaihei 4-176034, published on Jun. 23, 1992). In the laser-assisted magnetic recording, recording and reproducing are carried out by using light irradiation to raise the temperature of a magnetic recording medium. The inventors of the present invention therefore considered that the magnetic recording medium of the present embodiment needed to be evaluated under the condition where the temperature of the magnetic recording medium is raised.

Note that, the magnetic recording medium 1 of the present embodiment employs the laser-assisted magnetic recording method. Namely, the magnetic recording medium 1 of the present embodiment carries out reproducing by reading a magnetic signal, unlike the medium employing a magneto-optical recording method as disclosed in Document 2. Thus, the magnetic recording medium 1 of the present embodiment does not require a transparent dielectric material which intensifies an optical signal (by increasing Kerr rotation angle of the medium) as described in Document 2.

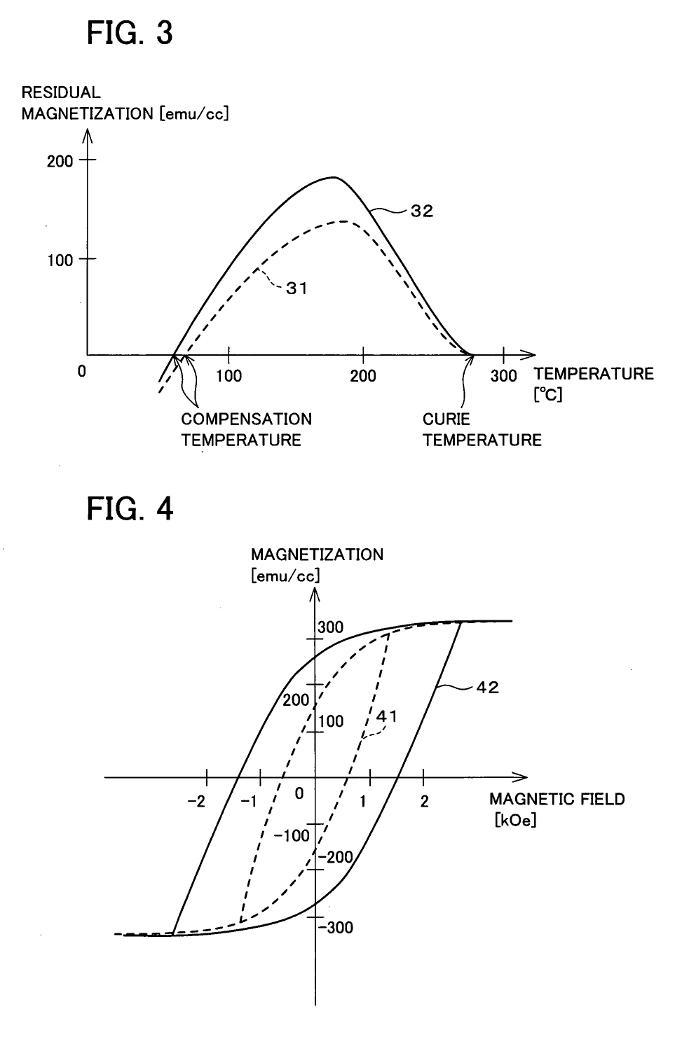

FIG. 3 shows the temperature dependency of the residual magnetization in the magnetic recording medium 1 and the magnetic recording medium 10. The curved line 31 indicates the temperature dependency of the residual magnetization in the magnetic recording medium 10 which is not provided with the metal layer 3 and the second magnetic layer 5. The curved line 32 indicates the temperature dependency of the residual magnetization in the magnetic recording medium 1 which is provided with the metal layer 3 and the second magnetic layer 5.

As shown in FIG. 3, the magnetic recording medium 1 has the compensation temperature and the Curie temperature approximately equal to those in the magnetic recording medium 10, whereas the magnetic recording medium 1 has a greater largest possible value of residual magnetization than that of the magnetic recording medium 10. Note that, the compensation temperature is a temperature at which staggered magnetizations in the ferrimagnet are canceled out so that the ferrimagnet has no spontaneous magnetization (or the compensation temperature may be defined as a temperature at which the total magnetization becomes apparently 0). Further, the Curie temperature is a secondary phase transition temperature between paramagnetism and ferrimagnetism (or the Curie temperature may be defined as a temperature at which the total magnetization becomes 0).

The foregoing results of experiments showed that, by providing the metal layer 3 and the second magnetic layer 5 to the magnetic recording medium 10, it is possible to increase the largest possible value of residual magnetization and thus intensify a signal that is to be detected by a magnetic head. Namely, by providing the metal layer 3 and the second magnetic layer 5, it is possible to reproduce information at a signal-to-noise ratio constantly above a certain level even if the size of the record unit is reduced for higher information recording density of the magnetic recording medium. In other words, it is possible to increase the information recording density in the magnetic recording medium by providing the metal layer 3 and the second magnetic layer 5.

Next, the inventors of the present invention diligently studied how the coercivity of the magnetic recording medium is influenced by providing the metal layer 3 and the second magnetic layer 5 to the magnetic recording medium 1.

Specifically, the magnetic recording medium 10 and the magnetic recording medium 1 whose temperatures were raised were compared with each other by using the VSM with respect to (A) the magnetic field dependency of the magnetization when a magnetic field was applied to the magnetic recording medium 10 and the magnetic recording medium 1 in a direction perpendicular to the film surface, and especially (B) the strength of the coercivity. Note that, the temperatures of the magnetic recording mediums were raised for evaluation because of the reason as discussed above.

FIG. 4 shows the magnetic field dependency of the magnetization in the magnetic recording medium 1 and the magnetic recording medium 10 whose temperatures are respectively raised to 200° C. In FIG. 4, the curved line 41 indicates the magnetic field dependency of the magnetization in the magnetic recording medium 10 which was not provided with the metal layer 3 and the second magnetic layer 5, and the curved line 42 indicates the magnetic field dependency of the magnetization in the magnetic recording medium 1 which was provided with the metal layer 3 and the second magnetic layer 5.

FIG. 4 shows that the coercivity of the magnetic recording medium 1 was larger than the coercivity of the magnetic recording medium 10. This reveals that the coercivity is increased by providing to the magnetic recording medium the metal layer 3 having a grained surface and the second magnetic layer 5.

The foregoing results of the comparison experiments revealed that the residual magnetization of the magnetic recording medium 1 is larger than the residual magnetization of the magnetic recording medium 10, and the coercivity of the magnetic recording medium 1 is larger than the coercivity of the magnetic recording medium 10.

In other words, it is possible to increase the total magnetization of the magnetic recording medium by (i) increasing a ratio of (A) the volume of the second magnetic layer 5 to (B) the sum of the volumes of the first magnetic layer 4 and the second magnetic layer 5, and (ii) providing the metal layer 3 to the magnetic recording medium. Therefore, even if the sum of the volumes of the first magnetic layer 4 and the second magnetic layer 5 is reduced, it is possible to maintain the total magnetization of the magnetic recording medium by (i) increasing the ratio of the second magnetic layer 5 to the sum of the volumes and (ii) providing the metal layer 3.

Namely, by providing the metal layer 3 and the second magnetic layer 5, it is possible to intensify the signal that is to be detected by the magnetic head, so as to increase the signal-to-noise ratio, or it is possible to increase the information recording density in the magnetic recording medium while maintaining the signal-to-noise ratio above a certain level.

Note that, in the present embodiment, roughness is formed under the first magnetic layer 4 by forming on the substrate 2 the metal layer 3 having a rough surface. This roughness has a pinning effect on the domain-wall movement of the first magnetic layer 4, thereby maintaining the total magnetization of the magnetic recording medium. In this respect, a nonmagnetic intermediate layer is provided between a magnetic flux forming layer and a reproducing layer in Tokukai 2001-134994, but this nonmagnetic intermediate layer is provided for increasing a Kerr rotation angle in reproducing. On the other hand, the metal layer 3 of the present embodiment is provided for forming roughness under the first magnetic layer 4. Note that, it is most preferable to provide the metal layer 3 as an underlayer of the first magnetic layer 4 in order to form roughness under the first magnetic layer 4 as in the present embodiment. If the underlayer of the first magnetic layer 4 is made of nonmetal, roughness is hardly formed.

(Arrangement of a Recording-Reproducing Device)

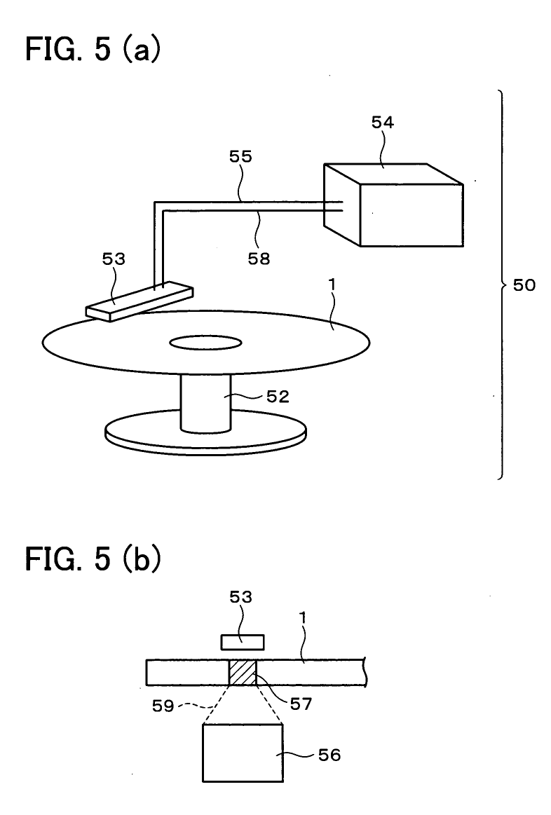

FIG. 5(a) is a perspective view of a recording-reproducing device (recording device and reproducing device) 50 which uses the magnetic recording medium 1 as described above. FIG. 5(b) is a cross-sectional view of a part of the recording-reproducing device 50 in the vicinity of the magnetic recording medium. Note that, a recording-reproducing device 50 having the function of recording and reproducing is used as an example of a reproducing device in the present embodiment, but the reproducing device may have only the function of reproducing without the function of recording. Further, the present embodiment uses as an example of a recording device a recording-reproducing device 50 having the function of recording and reproducing, but the recording device may have only the function of recording without the function of reproducing.

As shown in FIG. 5(b), the recording-reproducing device 50 is provided with a driving device 52 which rotates the magnetic recording medium 1, heating means 56 which heats the magnetic recording medium 1, and a magnetic head 53. The recording-reproducing device 50 records information by using the magnetic head 53 that applies a magnetic field on a portion 57 of the magnetic recording medium 1, the portion 57 being heated by an optical beam 59 projected from the heating means 56. The recording-reproducing device 50 reproduces information by using the magnetic head 53 that detects the magnetization of the portion 57 heated by the optical beam 59 projected from the heating means 56 as such.

The magnetic head 53 is supported by supporting means (not shown) and the motion of the magnetic head 53 is controlled by the supporting means. Further, the magnetic head 53 is connected to a signal source 54 via a recording signal line 55 and a reproducing signal line 58, as shown in FIG. 5(a).

The signal source 54 supplies a current having a desired frequency via the recording signal line 55 to a magnetic field generating section (such as a coil) of the magnetic head 53, so that it is possible to generate a magnetic field and apply the magnetic field to the magnetic recording medium 1. Further, a reproduction signal detected by a magnetization detecting section of the magnetic head 53 is sent to the signal source 54, and then outputted to the outside.

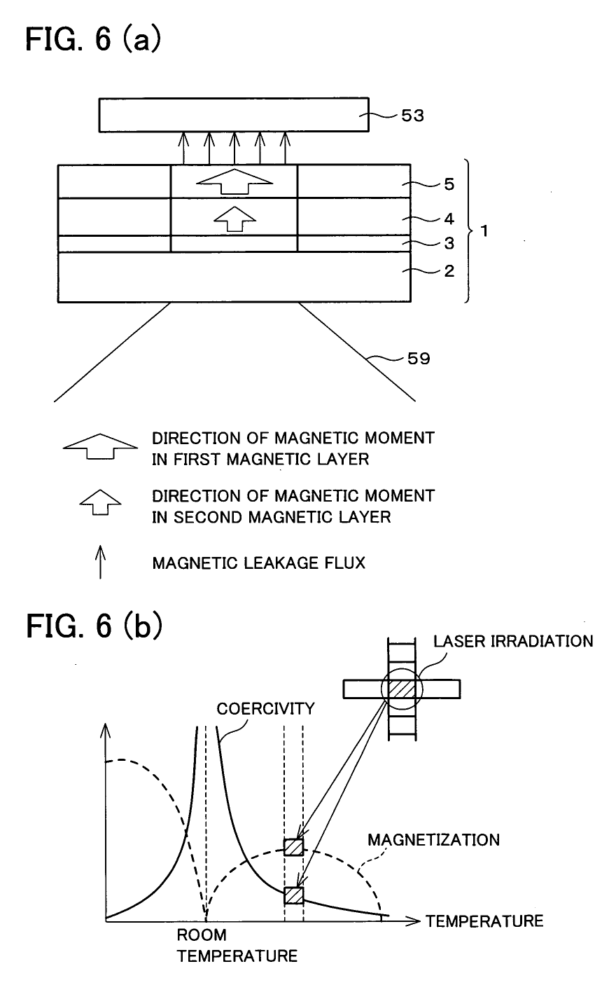

FIG. 6(a) shows the magnetic recording medium in the recording-reproducing device during recording and reproducing. The present embodiment will explain the total coercivity and the temperature dependency of the total magnetization in the magnetic recording medium that has the first magnetic layer 4 and the second magnetic layer 5 whose compensation temperatures are both room temperature.

Note that, the total magnetization of the magnetic recording medium depends largely on the magnetization of the second magnetic layer 5, because the magnetization of the second magnetic layer 5 is larger than the magnetization of the first magnetic layer 4. Further, the total coercivity of the magnetic recording medium depends largely on the coercivity of the first magnetic layer 4, because the coercivity of the first magnetic layer 4 is larger than the coercivity of the second magnetic layer 5.

When heating the magnetic recording medium 1 by using the optical beam 59 during recording, the coercivity of the magnetic recording medium 1 decreases as shown in FIG. 6(b). Accordingly, the magnetic field applied by the magnetic head 53 aligns the magnetic moment of both the first magnetic layer 4 and the second magnetic layer 5 uniformly in one direction at a portion of the magnetic recording medium 1 where the heating decreases the coercivity below a certain value. With this, magnetic information is recorded.

On the other hand, the magnetic moment of the magnetic recording medium 1 is not aligned uniformly in one direction at a portion which is heated insufficiently so as to retain larger coercivity than the magnetic field applied by magnetic head 53. Thus, the recording of the magnetic information is prohibited in such portion of the magnetic recording medium 1.

In this manner, by locally heating a specific portion of the magnetic recording medium 1 by using the optical beam 59, it is possible to selectively magnetize the magnetic recording medium 1. Further, since the optical beam 59 can heat an area smaller than the magnetic head 53, the use of the optical beam 59 makes it possible to magnetize uniformly in one direction the magnetic moment of an area smaller than the magnetic head 53, thereby recording magnetic information in such a small area.

Further, when heating the magnetic recording medium 1 by using the optical beam 59 during reproducing, the magnetization of the magnetic recording medium 1 increases as the temperature rises, and then decreases after reaching a certain temperature, as shown in FIG. 6(b). Accordingly, the magnetic head 53 can detect magnetic leakage flux from the first magnetic layer 4 and the second magnetic layer 5 at a portion of the magnetic recording medium 1 where the magnetization increases above a certain value after heated by the optical beam 59. With this, it is possible to reproduce magnetic information.

On the other hand, as the temperature lowers toward room temperature, the magnetization of the magnetic recording medium 1 decreases at a portion that is not sufficiently heated. Here, the magnetization is not detected where the magnetization becomes lower than a detection limit.

In this manner, by heating a specific portion of the magnetic recording medium 1 by using the optical beam 59, it is possible to selectively detect the magnetization of the magnetic recording medium 1. Further, with the recording-reproducing device 50 of the present embodiment, the optical beam 59 can heat a smaller area than the magnetic head 53, thereby detecting the magnetization of an area smaller than the magnetic head 53.

As described above, a magnetic recording medium 1 of the present embodiment which includes a substrate 2 and a first magnetic layer 4 is arranged so as to include a second magnetic layer 5 having a greater largest possible absolute value of magnetization than the first magnetic layer 4 within a temperature range of from a room temperature to a Curie temperature; and a metal layer 3 made of metal having unspontaneous magnetization property.

In this arrangement, the magnetic recording medium 1 is provided with the second magnetic layer 5 and the metal layer 3. The inventors of the present invention compared the magnetic recording medium 1 with the magnetic recording medium 10 which is not provided with the second magnetic layer 5 and the metal layer 3 (hereinafter referred to as magnetic recording medium 10 for comparison) with respect to the coercivity and the temperature dependency of the magnetization. Note that, the sum of the volumes of the first magnetic layer 4 and the second magnetic layer 5 in the magnetic recording medium 1 was set to be equal to the volume of the first magnetic layer 4 in the magnetic recording medium 10 for comparison.

Diligent studies revealed that the magnetic recording medium 1 has larger coersivity and larger magnetization than the magnetic recording medium 10 which is not provided with the second magnetic layer 5 and the metal layer 3.

These results of comparison show that it is possible to increase the total coercivity and magnoetization of the magnetic recording medium 1 by (i) increasing a ratio of (A) the volume of the second magnetic layer 5 to (B) the sum of the volumes of the first magnetic layer 4 and the second magnetic layer 5, and (ii) providing the metal layer 3 to the magnetic recording medium 1. Therefore, even if the sum of the volumes of the first magnetic layer 4 and the second magnetic layer 5 is reduced, it is possible to maintain the total coercivity and magnetization of the magnetic recording medium 1 by (i) increasing the ratio of the second magnetic layer 5 to the sum of the volumes and (ii) providing the metal layer 3.

Namely, by providing the metal layer 3 and the second magnetic layer 5, it is possible to have a higher coercivity and magnetization of the magnetic recording medium 1 even if the size of the record unit is small so as to have a higher information recording density of the magnetic recording medium 1. Therefore, it is possible to intensify the signal to be detected by the magnetic head 53 which reads information recorded on the magnetic recording medium 1, so as to increase the signal-to-noise ratio. Further, it is possible to increase the information recording density in the magnetic recording medium while maintaining the signal-to-noise ratio above a certain level.

Further, the magnetic recording medium 1 of the present embodiment is so arranged that a temperature that maximizes the absolute value of magnetization in the second magnetic layer 5 and a temperature that maximizes the absolute value of magnetization in the first magnetic layer 4 are substantially equal to each other within the range of from the room temperature to the Curie temperature.

With this arrangement, the temperature that maximizes the absolute values of magnetization in the first magnetic layer 4 and the second magnetic layer 5 is set to be a temperature for reproducing information. This enables to generate the largest possible magnetization available in the magnetic recording medium 1. Therefore, it is possible to further intensify the signal that is to be detected by the magnetic head 53 of the recording-reproducing device 50.

Further, the magnetic recording medium 1 of the present embodiment is so arranged that the second magnetic layer 5 is formed on a surface of the first magnetic layer 4, the surface facing a magnetic head 53 of a recording-reproducing device 50.

With this arrangement, it is possible to reduce the distance between the second magnetic layer 5 and the magnetic head 53. Here, the second magnetic layer 5 has a greater largest possible value of magnetization than the first magnetic layer 4. Thus, it can be assumed that the magnetization of the magnetic recording medium 1 is mainly generated by the second magnetic layer 5.

The distance between the second magnetic layer 5 and the magnetic head 53 is reduced in the magnetic recording medium 1 of the present embodiment, thereby allowing the magnetic head 53 to detect larger magnetization.

Further, the magnetic recording medium 1 of the present embodiment is so arranged that the first magnetic layer 4 includes at least one kind of rare earth metal and at least one kind of 3d transition metal.

With this arrangement, the first magnetic layer 4 can be formed as alloy including rare earth metal and 3d transition metal. The alloy including rare earth metal and 3d transition metal is alloy whose magnetic properties against temperature can be easily controlled. Accordingly, when the first magnetic layer 4 is formed as alloy including rare earth metal and 3d transition metal, the laser-assisted magnetic recording can be applied to the magnetic recording medium 1 of the present embodiment. Therefore, it is possible to improve the information recording density of the magnetic recording medium 1.

Further, the magnetic recording medium 1 of the present embodiment is so arranged that the second magnetic layer 5 includes (A) at least one kind of rare earth metal other than rare earth metal contained in the first magnetic layer 4, and (B) at least one kind of 3d transition metal.

With this arrangement, the second magnetic layer 5 can be arranged to have larger residual magnetization than the first magnetic layer 4. Therefore, the magnetic recording medium 1 of the present embodiment can generate large magnetization that cannot be achieved in a case where the second magnetic layer 5 is made of only the same elements as the elements contained in the first magnetic layer 4.

Further, with this arrangement, the second magnetic layer 5 can be so arranged as to be formed as alloy including rare earth metal and 3d transition metal. The alloy is alloy whose magnetic properties against temperature can be easily controlled. Accordingly, the laser-assisted magnetic recording can be applied to the magnetic recording medium 1 of the present embodiment. Therefore, it becomes possible to improve the information recording density of the magnetic recording medium 1.

Note that, the magnetic recording medium 1 of the present embodiment is preferably arranged so that the coercivity of the second magnetic layer 5 is not more than 3 kOe at a temperature for reproducing information recorded on the magnetic recording medium 1.

With the magnetic recording medium 1 as arranged above, a magnetic field generated by the magnetic head 53 during recording and the magnetization of the first magnetic layer 4 during reproducing can easily magnetize the magnetic recording medium 1 in a desired direction, so as not to hinder changes in magnetization during recording and reproducing.

Further, the magnetic recording medium 1 of the present embodiment is preferably arranged so that the thickness of the second magnetic layer 5 is not more than 10 nm. With this arrangement, the magnetic head 53 can be located closer to the first magnetic layer 4 so as to carry out recording by using a convergent magnetic field in the vicinity of the magnetic head 53, thereby recording information in higher density.

Further, a recording-reproducing device 50 of the present embodiment is arranged so as to include heating means 56 for locally heating a portion of a magnetic recording medium 1; and a magnetic head 53 for applying a magnetic field on the portion heated by the heating means 56.

With this arrangement, while the heating means 56 locally heats the magnetic recording medium 1, the magnetic head 53 can apply a magnetic field to the heated portion of the magnetic recording medium 1. Therefore, it is possible to carry out the laser-assisted magnetic recording on the magnetic recording medium 1, thereby recording information on the magnetic recording medium 1 in high density.

Further, a recording-reproducing device 50 of the present embodiment is arranged so as to include heating means 56 for locally heating a portion of a magnetic recording medium 1; and a magnetic head 53 for detecting magnetization of the portion heated by the heating means 56.

With this arrangement, while the heating means 56 locally heats the portion of the magnetic recording medium 1, the magnetic head 53 can reproduce information from the heated portion of the magnetic recording medium 1. Therefore, it is possible to read information from the magnetic recording medium 1 on which information is recorded in high density by the laser-assisted magnetic recording.

Further, the magnetic recording medium of the present invention may be arranged such that (i) a temperature that maximizes the absolute value of magnetization in the second magnetic layer and (ii) a temperature that maximizes the absolute value of magnetization in the first magnetic layer are substantially equal to each other within the range of from the room temperature to the Curie temperature.

With this arrangement, the temperature that maximizes the absolute values of magnetization in the first magnetic layer and the second magnetic layer is set to be a temperature for reproducing information. This enables to generate the largerst possible magnetization available in the magnetic recording medium. Therefore, it is possible to further intensify the signal that is to be detected by the magnetic head of the recording-reproducing device.

Further, the magnetic recording medium of the present invention may be arranged so that the second magnetic layer is formed on a surface of the first magnetic layer, the surface facing a magnetic head of a recording device or a reproducing device.

With this arrangement, it is possible to reduce the distance between the second magnetic layer and the magnetic head. Here, the second magnetic layer has a greater largest possible value of magnetization than the first magnetic layer. Thus, it can be assumed that the second magnetic layer mainly generates the magnetization of the magnetic recording medium.

The distance between the second magnetic layer and the magnetic head is reduced in the magnetic recording medium of the present invention, thereby allowing the magnetic head to detect larger magnetization.

Further, the magnetic recording medium of the present invention may be arranged so that the first magnetic layer includes at least one kind of rare earth metal and at least one kind of 3d transition metal.

With this arrangement, the first magnetic layer can be formed as alloy including rare earth metal and 3d transition metal. The alloy including rare earth metal and 3d transition metal is alloy whose magnetic properties against temperature can be easily controlled. Accordingly, when the first magnetic layer is formed as alloy including rare earth metal and 3d transition metal, the laser-assisted magnetic recording can be applied to the magnetic recording medium of the present invention. Therefore, it is possible to improve the information recording density of the magnetic recording medium.

Further, the magnetic recording medium of the present invention may be arranged so that the second magnetic layer includes (A) at least one kind of rare earth metal other than rare earth metal contained in the first magnetic layer, and (B) at least one kind of 3d transition metal.

With this arrangement, the second magnetic layer can be arranged to have larger residual magnetization than the first magnetic layer. Therefore, the magnetic recording medium of the present invention can generate large magnetization that cannot be achieved in a case where the second magnetic layer is made of only the same elements as the elements contained in the first magnetic layer.

Namely, the first magnetic layer and the second magnetic layer can be respectively arranged to be suitable for either recording or reproducing, such that the function of recording is assigned to the first magnetic layer having comparatively small magnetization and large coercivity, whereas the function of reproducing is assigned to the second magnetic layer having small coercivity and large magnetization.

Further, with this arrangement, the second magnetic layer can be formed as alloy including rare earth metal and 3d transition metal. The alloy is alloy whose magnetic properties against temperature can be easily controlled. Accordingly, the laser-assisted magnetic recording can be applied to the magnetic recording medium of the present invention. Therefore, it becomes possible to improve the information recording density of the magnetic recording medium.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A magnetic recording medium, comprising:
a substrate;
a metal layer formed on said substrate, said metal layer having unspontaneous magnetization property;
a first magnetic layer formed on said metal layer; and
a second magnetic layer formed on said first magnetic layer, said second magnetic layer having a greater largest possible absolute value of magnetization than said first magnetic layer within a temperature range of from a room temperature to a Curie temperature.

2. The magnetic recording medium as set forth in claim 1, wherein:
the largest possible absolute value of magnetization in said second magnetic layer is greater than the largest possible absolute value of magnetization in said first magnetic layer by not less than 1.2 times within the temperature range of from the room temperature to the Curie temperature.

3. The magnetic recording medium as set forth in claim 1, wherein:
a thickness of said second magnetic layer in a direction perpendicular to a surface of said substrate is not less than 10 nm and not more than 50 nm.

4. The magnetic recording medium as set forth in claim 1, wherein:
said first magnetic layer includes at least one kind of rare earth metal and at least one kind of 3d transition metal.

5. The magnetic recording medium as set forth in claim 1, wherein:
said first magnetic layer includes at least one kind of rare earth metal and at least one kind of 3d transition metal; and
said second magnetic layer includes (A) at least one kind of rare earth metal other than the rare earth metal contained in said first magnetic layer, and (B) at least one kind of 3d transition metal.

6. The magnetic recording medium as set forth in claim 1, wherein:
a temperature that maximizes the absolute value of magnetization in said second magnetic layer and a temperature that maximizes the absolute value of magnetization in said first magnetic layer are substantially equal to each other within the range of from the room temperature to the Curie temperature.

7. The magnetic recording medium as set forth in claim 1, wherein:
said metal layer has grains on a surface opposite to a surface facing said substrate.

8. The magnetic recording medium as set forth in claim 7, wherein:
each of the grains on said metal layer has a diameter of from 10 nm to 50 nm.

9. The magnetic recording medium as set forth in claim 7, wherein:
the grains are formed with a density of from 400 grains/μm² to 10000 grains/μm².

10. The magnetic recording medium as set forth in claim 1, wherein:
a thickness of said metal layer in a direction perpendicular to a surface of said substrate is approximately 10 nm.

11. The magnetic recording medium as set forth in claim 1, wherein:
a laser-assisted magnetic recording method is used for recording and reproducing.

12. A magnetic recording medium which includes a substrate and a first magnetic layer, comprising:
a second magnetic layer having a greater largest possible absolute value of magnetization than said first magnetic layer within a temperature range of from a room temperature to a Curie temperature; and
a metal layer made of metal having unspontaneous magnetization property.

13. The magnetic recording medium as set forth in claim 12, wherein:
a temperature that maximizes the absolute value of magnetization in said second magnetic layer and a temperature that maximizes the absolute value of magnetization in said first magnetic layer are substantially equal to each other within the range of from the room temperature to the Curie temperature.

14. The magnetic recording medium as set forth in claim 12, wherein:
said second magnetic layer is formed on a surface of said first magnetic layer, the surface facing a magnetic head of a recording device or a reproducing device.

15. The magnetic recording medium as set forth in claim 12, wherein:
said first magnetic layer includes at least one kind of rare earth metal and at least one kind of 3d transition metal.

16. The magnetic recording medium as set forth in claim 12, wherein:
said second magnetic layer includes (A) at least one kind of rare earth metal other than rare earth metal contained in said first magnetic layer, and (B) at least one kind of 3d transition metal.

17. A recording device, comprising:
heating means for locally heating a portion of a magnetic recording medium including a substrate, a first magnetic layer, a second magnetic layer having a greater largest possible absolute value of magnetization than said first magnetic layer within a temperature range of from a room temperature to a Curie temperature, and a metal layer made of metal having unspontaneous magnetization property; and
a magnetic head for applying a magnetic field on the portion heated by said heating means.

18. A reproducing device, comprising:
heating means for locally heating a portion of a magnetic recording medium including a substrate, a first magnetic layer, a second magnetic layer having a greater largest possible absolute value of magnetization than said first magnetic layer within a temperature range of from a room temperature to a Curie temperature, and a metal layer made of metal having unspontaneous magnetization property; and
a magnetic head for detecting magnetization of the portion heated by said heating means.
